(19) United States
(12) Patent Application Publication
(10) Pub. No.: US 2018/0011468 A1
(43) Pub. Date: Jan. 11, 2018

(54) ANCHOR TESTING DATA COLLECTION APPARATUS

(71) Applicant: RON SLACK, CASPER, WY (US)

(72) Inventor: RON SLACK, CASPER, WY (US)

(21) Appl. No.: 15/206,378

(22) Filed: Jul. 11, 2016

(51) Int. Cl. G05B 19/05; G01L 5/00

(52) U.S. Cl. CPC G05B 19/056; G01L 5/0033; G05B 2219/13144; G05B 2219/13052

(57) ABSTRACT

A tension testing apparatus is provided and allows a user to interface and collect real time data in remote locations. The user can collect, record and print anchor testing information that includes tension measurement load data, time, longitude, latitude and elevation of the load test.

### FIELD OF THE INVENTION

This invention relates generally to an apparatus for attachment to a vehicle located in remote sites in order to test and record test information related to the tension and load capabilities of anchors located at remote sites.

### BACKGROUND OF THE INVENTION

In the oil and gas industry it is often necessary to test the load or tension capabilities of a given anchor system located in remote areas and locations. Often, regulatory agencies seek to verify that the anchors used in remote areas and locations are capable and safe to use. The regulatory agencies often require a given anchor to have documented information in the form of printouts and electronic data available for regulatory inspection. The agency requirements often demand that a given anchor hold a load for a given period of time. Often a 20,000 pound test lasting two minutes in duration is required on a given anchor in the field. Thus, the operators in the field need to produce the testing information which verifies location, often longitude, latitude and elevation, as well as a known tension and time testing verification. Thus, there is a long felt need in the industry of anchor testing for an apparatus to print out and save electronic data verifying or certifying a oven anchor in a specific location.

### SUMMARY OF THE INVENTION

Accordingly, it is an object of embodiments of the present invention to provide an apparatus that allows testing a load and providing verifiable printouts and electronic data certifying and/or verifying an anchor qualifies per a given regulatory or agency demand or requirement.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims. To achieve the foregoing and other objects, and in accordance with the purposes of the present invention, as embodied and broadly described herein, the invention comprises an anchor testing data collection apparatus for documenting time, pressure and location of anchor load testing measurements, said anchor testing apparatus comprising: a programmable logic controller having a data logging program and an internal clock; a human machine interface having a screen interface portal, a global positioning information receiver; a pressure transducer measurement device; an analog to digital conversion module; a ladder logic convert block; a memory device; and a printer, said programmable logic controller in communication with said internal clock and said internal clock in communication with said ladder logic convert block, said programmable logic controller in communication with said human machine interface and said human machine interface in communication with said ladder logic convert block, said programmable logic converter in communication with said global positioning information receiver and said global positioning information receiver in communication with said ladder logic convert block, said programmable logic controller in communication with said pressure transducer measurement device and said pressure transducer measurement device in communication with said analog to digital conversion module, said analog to digital conversion module in communication with said ladder logic convert block; said programmable logic controller in communication with said printer, said printer in communication with said ladder logic convert block, said programmable logic controller in communication with said memory device and said memory device in communication with said ladder logic convert block.

Benefits and advantages of the present invention include, but are not limited to, providing an apparatus that produces both printouts and electronically stored information suitable to regulatory demands of verified anchor testing data in remote locations.

### BRIEF DESCRIPTION OF THE DRAWINGS

The invention can be best understood by those having ordinary skill in the art by reference to the following detailed description when considered in conjunction with the accompanying drawings in which:

FIG. 1 depicts a schematic and drawing of the instant invention showing the various components necessary to achieve the purposes of testing electronic load information, time and location at the site of an anchor in the field.

FIG. 2 depicts one embodiment of the instant invention disposed in a chassis and secured to a vehicle and in configuration to test an anchor load.

### DETAILED DESCRIPTION OF THE INVENTION

Reference will now be made in detail to embodiments of the invention, examples of which are illustrated in the accompanying drawings. Throughout the following detailed description, the same reference characters refer to the same or similar elements in all figures.

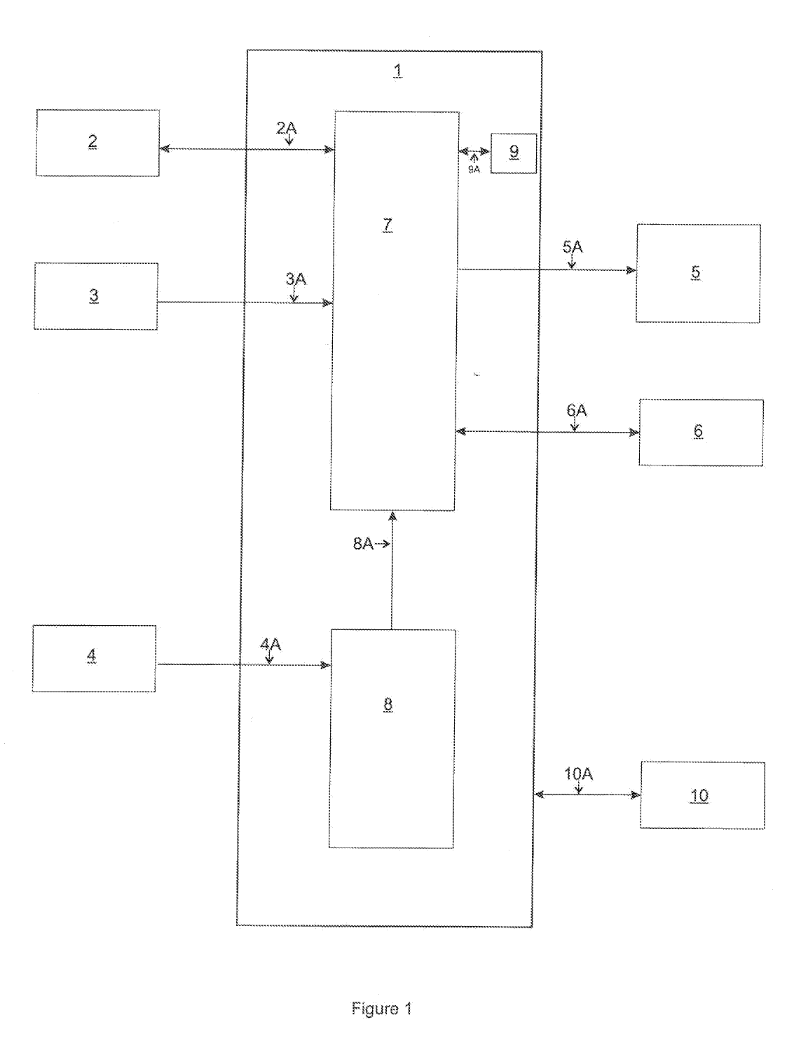

FIG. 1 depicts one embodiment of an anchor testing data collection apparatus for documenting time, tension and location of anchor test measurements. The focal point of the test and information gathering apparatus is the programmable logic controller 1 having a ladder logic convert block 7 and an internal clock 9. The programmable logic controller 1 also comprises a data to logging program which stores various data obtained from the devices in communication with the programmable logic controller 1.

The devices in communication with the programmable logic controller 1 include a pressure transducer measurement device 4, an analog to digital converter 8, a global positioning system information receiver 3, a human machine interface 2 having a screen interface portal, a memory device 6, and a printer 5. In another embodiment of the invention, the programmable logic controller includes and is in communication with a universal serial bus port 10.

The data logging program is logic embedded in the programmable logic controller 1 and the memory device 8, typically an SD memory card. The data logging program unctions to collect and to convert the various conventional data streams into programmable logic controller 1 and other device compatible data streams as well as saving and preserving data to the memory device 6. The data logging program activates the programmable logic controller 1 by a sending a create instruction embedded in the programmable logic controller logic system. The create instruction configures the data ladder logic convert block 7, which receives and stores all the data that is gathered, used, manipulated and stored during operation and sends the data to the memory device 6. The create instruction also sets up the format for the .csv file. The .csv file data is laid out to fit in a spread sheet format for access independent of testing operations. The .csv file comprises ASCII strings and numerical values in the data. The ASCII strings and numerical values arrive from the interfaces of the human machine interface 2, GPS 3, and the pressure transmitter 4, which is sent into the programmable logic controller 1 and the memory device 6 for storage.

The data may be saved when the programmed programmable logic controller instruction opens the .csv file, the operator, using the human machine interface 2, communicates with the programmable logic controller 1 to save the data collected from the various devices. After the testing is done, either the operator at the human machine interface 2 ceases collection of the test data or the operator previously activated a predetermined collection time and the programmable, logic controller 1 ceases data collection. The programmable logic controller 1 closes the .csv and the data is stored. The .csv file is transferred by programmable logic controller 1 internal communication to a memory device 6.

The programmable logic controller 1 is in communication with the GPS 3 as data is communicated and confirmed via ASCII and numerical communication between the two devices 3A. The GPS information contains latitude, longitude and elevation information and is transferred to the programmable logic controller ire an ASCII string format. The programmable logic controller 1 verifies the length of the ASCII string due to multiple data strings 3A from the GPS 3. The correct data is received once every second. The ASCII string is moved into a buffer if the correct length is verified by programmable logic controller 1. The programmable logic controller 1 separates the latitude, longitude, and elevation from the string after it verifies the correct character in the 17^{th} (numeric) position in the ASCII string. The programmable logic controller 1 uses a ladder logic “Equal To” instruction for the 17^{th} position verification. The latitude, longitude, and elevation data 2A is communicated from the programmable logic controller 1 to the human machine interface 2, data logging program, and printer.

The global positioning system information receiver receives location and elevation information and sends data to the human machine interface via the programmable logic controller is display only format. The data logging program stores the global positioning system information receiver data with each test to be recalled later. The printer requires that the global positioning system information receiver data sent to the programmable logic controller 1 then to the printer 5 to be converted to hex byte communication format 5A so that the printer 5 can read the data. The programmable logic controller 1 changes ASCII to characters then to hex byte format with the use of the ladder logic convert blocks 7. The hex byte communication format 5A is then converted back to ASCII format by the printer internal software. Typical printers used are Zebra™ brand kiosk-style printers.

The human machine interface 2 generates information data in ASCII and numerical value format and communicates this information to and from the programmable logic controller 1 in a profinet packet format 2A. The profinet packet format communication 2A is manipulated by the data logging program of the programmable logic controller 1 and sent to the ladder logic convert block, memory device 6 and printer 5. The data logging program of the programmable logic controller 1 stores the human machine interface data with each test in the programmable logic controller 1 and the memory device 6 to be recalled later.

The printer 5 requires that the human machine interface data exist in a hex byte format that the printer 5 can read. Thus, the programmable logic controller 1 converts the human machine interface ASCII data format and integer data (numerical value) into characters and then into hex byte format with the use of the ladder logic convert blocks 7. The programmable logic controller 1 communicates the information via hex byte format 5A between the programmable logic controller 1 and the printer 5.

During anchor testing measurements, the pressure transducer measurement device 4 produces and communicates a raw analog signal value 4A that is sent to the programmable lope controller 1 and then transferred to the analog to digital converter 8. In the analog to digital converter 8, the communicated raw analog signal value 4A from the pressure transducer measurement device 4 is converted to a “NORM X” integer value format, then to real scaled digital value and then into a double integer value. The real value is used in “Scale X” to set the high & low value to a double integer. The double integer represents pounds of force from the pressure test measurement as obtained for the pressure transducer measurement device 4. The analog to digital converter double integer value is communicated 8A to the programmable logic controller 1 and ladder logic convert block 7. The data logging program stores the pressure transmitter data with each test in both the programmable logic controller 1 the memory device 6 to be recalled later.

The printer 5 requires that the pressure transmitter data be communicated in the hex byte format 5A for the printer to read. Thus, the programmable logic controller 1 changes ASCII and integer data to characters then to hex bytes with the use of the ladder logic convert block 7 in communication 5A between the programmable logic controller 1 and the printer 5.

The programmable logic controller 1 is in communication with the universal serial bus port 10. The programmable logic controller 1 and the universal serial bus port 10 communication 10A is typically in a .csv format or ASCII format. The universal serial bus port 10 allows for information be transferred to a computer or to a device to provide for remote or off site testing control.

The programmable logic controller internal clock 9 sends clock data time information communication 9A to the ladder logic convert block 7 of the programmable logic controller 1, which sends the time information to the human machine interface 2 for user review on the screen interface portal, not depicted. The human machine interface 2 sends that information back to the programmable logic controller 1 and ladder logic convert block 7 with communication information input into the human machine interface 1 by the user. Additionally, the data logging program stores the clock data with each test. Information from the programmable logic controller and the ladder logic convert block to and from a memory device in communication 6A and is typically in a .csv file format.

The printer 5 requires that the clock data be communicated in a format 9A that the printer can read. Thus, the programmable logic controller 1 changes ASCII and integer data communication 9A from the internal clock 9 to characters then to hex bytes with the use of the ladder logic convert blocks.

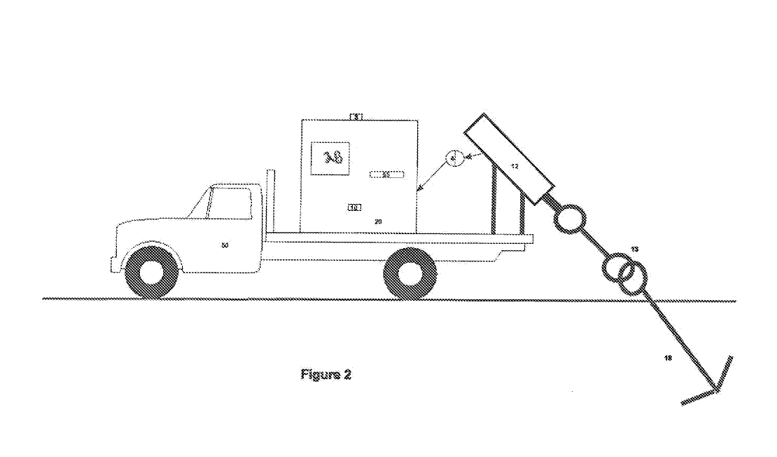

FIG. 2 depicts the programmable logic controller 1 disposed inside a chassis 20, which is mounted to a vehicle 50. The chassis provides protection for the programmable logic controller 1 and its electronic devices and circuitry. Such protection is useful oven the wide variety of locations and environments in which the anchor testing data collection apparatus is used. The pressure transducer measurement device 4 is in communication with a hydraulic cylinder 12. The hydraulic cylinder 12 is attached to an anchor 19 by anchor attachment 13. The chassis 20 has the screen interface portal 2B of the human machine interface mounted for user data input and data review. The interface portal 2B provides a means for a user to communicate with the programmable logic controller, not depicted. The user provides identification for a specific anchor 19, such as well number, testing conditions, etc., and additional specific site location information as well as commencing and ceasing the testing of the load. The chassis 20 also has the universal serial bus port 10 mounted to provide for easy data collection or control of the test. The chassis 20 further has a slot 55 for printed paper from the printer 5 to emerge and be collected by the user.

Paper preloaded into the kiosk-style printer 6, not depicted in FIG. 2 is printed after any test and contains the corresponding test information. The relevant testing information includes time, GPS location (longitude, latitude, elevation) and pressure testing for a particular load as well as any test duration information. Additionally, the printer transfers the testing data to the printed paper for collection and storage. One advantage is that the printed paper output from the printer after testing may be stored on site or even affixed to the anchor apparatus for verification by operators and oversight bodies during inspection. The global positioning system information receiver 3 is also depicted attached to the chassis 20.

It is believed that the apparatus of the present invention and many of its attendant advantages will be understood from the foregoing description. It is also believed that it will be apparent that various changes may be made in the form, geometry, construction, and arrangement of the components without departing from the scope and spirit of the invention and without sacrificing its material advantages. The forms described are merely exemplary and explanatory embodiments thereof. It is the intention of the following claims to encompass and include such changes.

What is claimed is:

1. An anchor testing data collection apparatus for documenting time, pressure and location of anchor load testing measurements, said anchor testing data collection apparatus comprising: a programmable logic controller having a data logging program and an internal clock; a human machine interface having a screen interface portal, a global positioning information receiver; a pressure transducer measurement device; an analog to digital conversion module; a ladder lope convert block; a memory device; and a printer, said programmable logic controller in communication with said internal clock and said internal clock in communication with said ladder logic convert block, said programmable logic controller in communication with said human machine interface and said human machine interface in communication with said ladder logic convert block, said programmable logic converter in communication with said global positioning information receiver and said global positioning information receiver in communication with said ladder logic convert block, said programmable logic controller in communication with said pressure transducer and said pressure transducer in communication with said analog to digital conversion module, said analog to digital conversion module in communication with said ladder logic convert block; said programmable logic controller in communication with said printer, said printer in communication with said ladder logic convert block, said programmable logic controller in communication with said memory device and said memory device in communication with said ladder logic convert block.

2. The anchor testing apparatus of claim 1, wherein the printer further comprises paper adaptable to printout information communicated from the programmable logic controller and ladder logic convert block.

3. The anchor testing apparatus of claim 1, wherein the pressure transducer measurement device is in communication with a hydraulic cylinder.

4. The anchor testing apparatus of claim 3, wherein the hydraulic cylinder applies tension via an attachment to an anchor.

5. The anchor testing apparatus of claim 1, wherein the global positioning system is in communication with satellites to determine longitude, latitude and elevation of the global positioning system.

6. The anchor testing apparatus of claim 1, wherein the programmable logic controller is disposed inside a chassis.

7. The anchor testing apparatus of claim 6, wherein the human machine screen interface portal is mounted to the chassis.

8. The anchor testing apparatus of claim 6, further comprising a universal serial bus port in communication with said programmable logic controller.

9. The anchor testing apparatus of claim 8, wherein the communication between said programmable logic controller and said universal serial bus port comprises .csv files comprised of ASCII string and numerical values.

10. The anchor testing apparatus of claim 8, wherein the universal serial bus port is mounted to the chassis.

11. The anchor testing apparatus of claim 1, wherein the apparatus is mounted to a vehicle.

12. The anchor testing apparatus of claim 1, wherein the communication between said internal clock and said ladder logic convert block comprises clock data time

13. The anchor testing apparatus of claim 1, wherein the communication between said ladder logic convert blocks and said human machine interface comprises profinet packets.

14. The anchor testing apparatus of claim 1, wherein the communication between said global positioning information receiver and said ladder logic convert block comprises hex byte format.

15. The anchor testing apparatus of claim 1, wherein the communication between said pressure transducer and said analog to digital conversion nodule comprises an analog signal.

16. The anchor testing apparatus of claim 1, wherein the communication between said analog to digital conversion module and said ladder logic convert block comprises digital converter double integer values.

17. The anchor testing apparatus of claim 1, wherein the communication between said printer and said ladder logic convert block comprises hex byte format.

18. The anchor testing apparatus of claim 1, wherein the communication between said memory device and said ladder logic convert block comprises .csv files comprised of ASCII string and numerical values.

19. An anchor testing data collection apparatus for documenting time, pressure and location of anchor load testing measurements, said anchor testing data collection apparatus comprising: a programmable logic controller having a data logging program and an internal clock; a human machine interface having a screen interface portal, a global positioning information receiver; a pressure transducer measurement device; an analog to digital conversion module; a ladder logic convert block; a memory device; a universal serial bus port; and a printer, said programmable logic controller in communication with said internal clock and said internal clock in communication with said ladder logic convert block, said programmable logic controller in communication with said human machine interface and said human machine interface in communication with said ladder logic convert block, said programmable logic converter communications with said global positioning information receiver and said global positioning information receiver in communication with said ladder logic convert block, said programmable logic controller in communication with said pressure transducer and said pressure transducer in communication with said analog to digital conversion module, said analog to digital conversion module in communication with said ladder logic convert block; said programmable logic controller in communication with said printer, said printer in communication with said ladder logic convert block, said programmable logic controller in communication with said memory device and said memory device in communication with said ladder logic convert block, said programmable logic controller in communication with said universal serial bus port.

20. The anchor testing data collection apparatus of claim 19, wherein the anchor testing data collection apparatus is is disposed inside a chassis.
